(19) United States
(12) Patent Application Publication
(10) Pub. No.: US 2024/0381422 A1
(43) Pub. Date: Nov. 14, 2024

(54) PREAMBLE PUNCTURING OF THE PRIMARY CHANNEL

(71) Applicant: Cisco Technology, Inc., San Jose, CA (US)

(72) Inventors: Ardalan ALIZADEH, Milpitas, CA (US); Vishal S. DESAI, San Jose, CA (US); Brian D. HART, Sunnyvale, CA (US); Peiman AMINI, Fremont, CA (US)

(21) Appl. No.: 18/316,115

(22) Filed: May 11, 2023

(51) Int. Cl. H04W 74/08

(52) U.S. Cl. CPC H04W 74/0816

(57) ABSTRACT

Embodiments herein transmit and receive in a secondary channel when a primary channel is active. In the embodiment, an access point determines that the primary channel is active, which may include waiting until a MAC header of a frame transmitted over the primary channel is decoded. In some embodiments, the access point tests that the received power is below a threshold. When it is determined that the primary channel is active and the received power is below the threshold, the access point transmits an RTS frame and receives a CTS frame over the secondary channel to reserve the secondary channel for a specified duration. In some embodiments, the access point uses NAV tracking to determine the duration of use of the primary channel to avoid collisions on the primary channel.

### TECHNICAL FIELD

Embodiments presented in this disclosure generally relate to the physical layer of wireless networking. More specifically, embodiments disclosed herein include the use of bandwidth available according to IEEE 802.11.

### BACKGROUND

Preamble puncturing allows an 802.11ax compatible access point to transmit data on a “punctured” 80 MHz channel or 160 MHz channel if some of the secondary channels are already in use by nearby legacy radio operating in an overlapping basic service set (OBSS). 802.11be also improves preamble puncturing by providing the multi-resource unit (multi-RU) capability in the data field. The 802.11ax standard also provides improvements, such as using INACTIVE_SUBCHANNELS from RXVECTOR to prevent a station (STA) from transmitting duplicated control physical protocol data units (PPDUs) in punctured subchannels. However, the 80 MHz or 160 MHz can only be punctured on secondary channels and never on the primary channel. This means that the entire 160 MHz bandwidth can be idle because of a low-end/legacy 20 MHz transmission of a client in an OBSS.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a basic service set (BSS) and an overlapping BSS.

FIG. 2 depicts a representative architecture of an access point.

FIG. 3 depicts arrangements of channels for various frequency bands.

FIG. 4 depicts legacy puncturing.

FIG. 5 depicts the operation of a primary channel without puncturing.

FIG. 6 depicts puncturing by a primary channel, in an embodiment.

FIG. 7 depicts puncturing by a primary channel with a request to send (RTS)/clear to send (CTS), in an embodiment.

FIG. 8 depicts a flow of operations for a transmitter, in an embodiment.

FIG. 9 depicts a flow of operations for a receiver, in an embodiment.

FIG. 10 depicts a flow of operations for a function that determines whether a primary channel is active, in an embodiment.

FIG. 11 depicts a flow of operations for a test power function, in an embodiment.

FIG. 12 depicts a flow of operations for a nav_tracking function, in an embodiment.

FIG. 13 depicts a flow of operations for a select_secondary_channel function, in an embodiment.

FIG. 14 depicts a flow of operations for a Test_Power function for the receiver, in an embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method of transmitting and receiving in a secondary channel when a primary channel is active. The method includes enabling activity over the secondary channel of a basic service set (BSS) operating in a wireless medium when the primary channel of the BSS is active, determining that the primary channel is active, transmitting an RTS frame over the secondary channel to reserve the secondary channel for a specified duration and receiving a CTS frame in the secondary channel in response to the RTS frame upon determining that the primary channel is active, and transmitting data over the secondary channel.

Another embodiment presented in this disclosure is an access point for transmitting and receiving in a secondary channel when a primary channel is active. The access point includes a processor; and a memory coupled to the processor and storing an application configured to, when executed by the processor, perform an operation. The operation includes enabling activity over the secondary channel of a basic service set (BSS) operating in a wireless medium when the primary channel of the BSS is active, determining that the primary channel is active, upon determining that the primary channel is active, transmitting an RTS frame over the secondary channel to reserve the secondary channel for a specified duration and receive a CTS frame in the secondary channel in response to the RTS frame, and transmitting data over the secondary channel.

Another embodiment presented in this disclosure is a non-transitory computer-readable medium encoding instructions, which, when executed by a processor of an access point coupled to a wireless medium, cause the access point to: enable activity over a secondary channel when a primary channel of a basic service set (BSS) is active, determine that the primary channel is active, upon determining that the primary channel is active, transmit an RTS frame over the secondary channel to reserve the secondary channel for a specified duration and receiving a CTS frame in the secondary channel in response to the RTS frame, and transmit data over the secondary channel.

### EXAMPLE EMBODIMENTS

The IEEE 802.11 standard provides a channel plan in which many 20 MHz channels can be aggregated or bonded to form wider bandwidths such as 40 MHz, 80 MHz, 160 MHz, and even 320 MHz channels. In earlier versions of the standard, 20 MHz channels being used by an OBSS legacy user posed no actual loss because only 20 MHz channels were available. However, when channels are bonded into larger bandwidth channels, the use of a primary 20 MHz channel by an OBSS creates an actual loss because the larger bandwidth could not be used while the OBSS 20 MHZ channel was active.

Preamble puncturing is an optional feature introduced in Wi-Fi 6 or 802.11ax that improves spectral efficiency by allowing a Wi-Fi 6 access point (AP) to transmit a “punctured” portion of the spectrum channel if legacy users are using some channels. However, this improvement only applies to the use of a secondary channel by a legacy OBSS. If a primary channel (of any size) is being used by a legacy OBSS, then the larger bandwidth of aggregated channels is still unusable. Embodiments provided herein allow the use of channels, including larger bandwidth aggregated channels, even if the primary channel is used by a legacy OBSS.

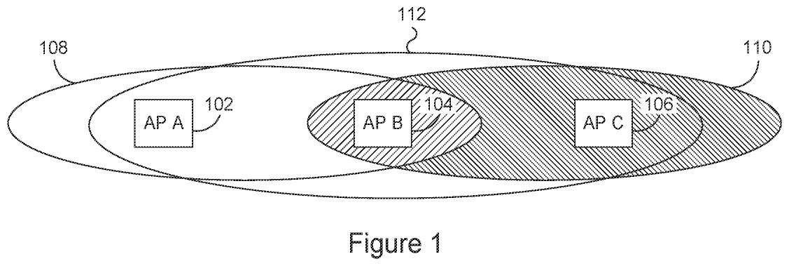

FIG. 1 depicts an arrangement of a number of basic service sets (BSSs). BSS A with access point (AP) A 102 is in range 108 with AP B 104 in BSS B and AP C 106 in BSS C is in range 110 with AP B 104 in BSS B. However, access points or STAs in BSS A and BSS C are out of range. After a STA in BSS B transmits in range 112, its transmission is heard by all STAs in all BSSs. In the following description, BSS A is referred to as the desired BSS and BSS C is referred to as the neighboring/interfering BSS.

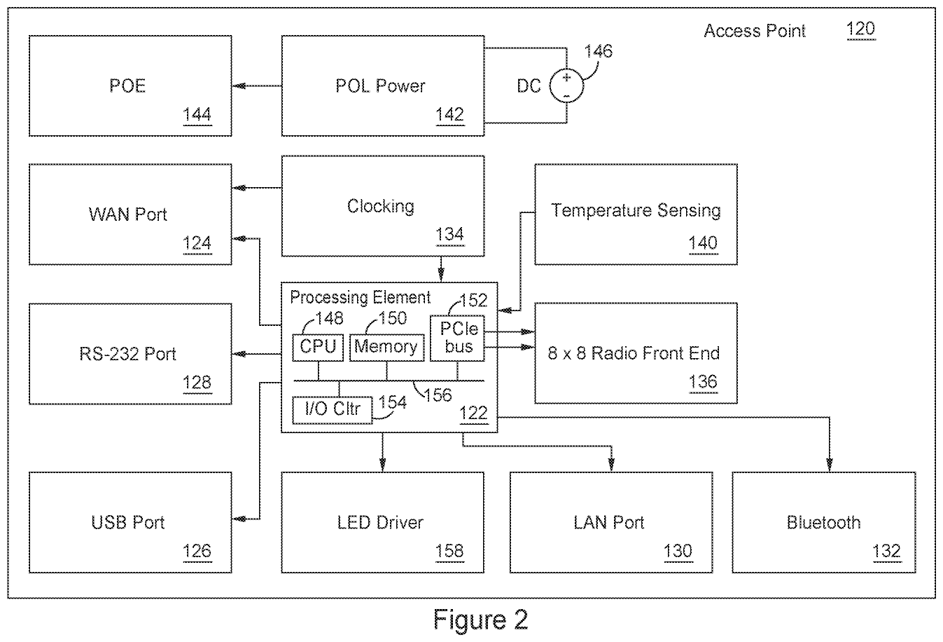

FIG. 2 depicts a representative architecture of an access point. The access point 120 includes a processing element 122 and several ports or connection facilities, such as a WAN port 124, USB port 126, RS-232 port 128, LAN port 130, and Bluetooth 132. Also included are a clocking system 134 and an 8×8 radio front-end 136 with a transmitter and receiver, which are coupled to eight external antennas. Auxiliary modules include a temperature sensing module 140, a power module 142 connected to a DC power source 146, a power over Ethernet (POE) module 144, and LED Driver 158. Processing element 122 includes a CPU 148 and memory 150, a peripheral control interconnect express (PCIe) bus controller 152 for connecting to the radio front end 136, and an I/O controller 154, all coupled to each other via bus 156.

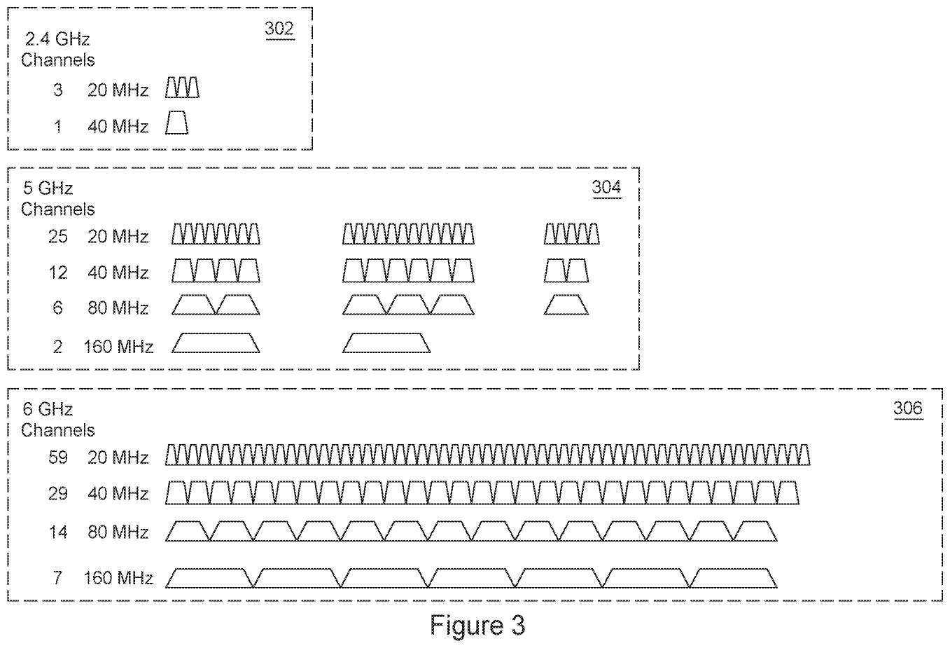

FIG. 3 depicts arrangements of channels for various frequency bands. The 2.4 GHz band 302 includes 3 20 MHz channels and 1 40 MHz channel including 2 20 MHz channels. The 5 GHz band 304 includes 25 20 MHz channels or 12 40 MHz channels or 6 80 MHz channels, or 2 160 MHz channels, where channels greater than 20 MHz are an aggregation of 20 MHz channels. The 6 GHz band 306 includes 59 20 MHz channels, 29 40 MHz channels, 14 80 MHz channels, or 7 160 MHz channels, where channels greater than 20 MHz are an aggregation of 20 MHz channels. A channel may be referred to by its center frequency, frequency range, or channel number. For example, in the 5 GHz band 306, 8 channels (channels 36, 40, 44, 48, 52, 56, 60, 64) reside in the frequency range of 5170-5330 MHz; 12 channels (100, 104, 108, 112, 116, 120, 124, 128, 132, 136, 140, 144) reside in the frequency range of 5490-5730 MHz; and 5 channels (149, 153, 157, 161, 165) reside in the frequency range of 5735-5835 MHz. Commonly used channels 36, 40, 44, 48, 52, 56, 60, and 64 have center frequencies of 5180, 5200, 5220, 5240, 5260, 5280, 5300, and 5320, respectively.

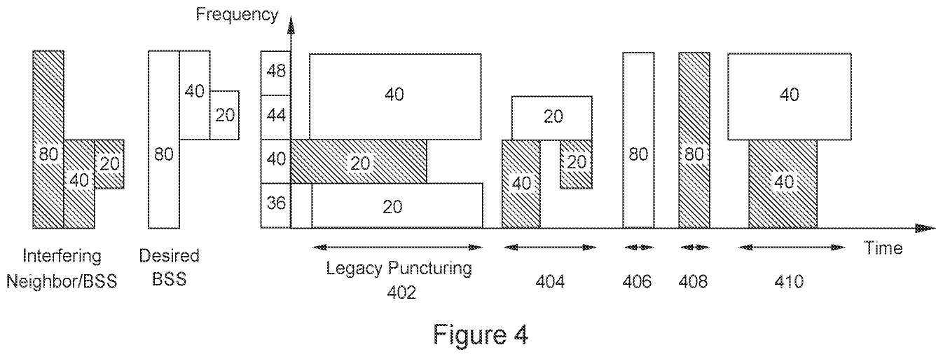

FIG. 4 depicts legacy puncturing, which allows the use of punctured secondary channels. In this arrangement, the primary channel is channel 44, and the secondary channels are channels 36, 40, and 48. In time period 402, a neighboring BSS operates on secondary channel 40. The desired BSS can operate on channel 36 and aggregated channels 44 and 48. In time period 404, the neighboring BSS first operates on aggregated channels 36 and 40 and then on channel 40. The desired BSS can still use primary channel 44. In time period 406, the desired BSS operates on aggregated channels 36-48. In time period 408, the neighboring BSS operates on aggregated channels 36-48. In time period 410, the neighboring BSS operates on aggregated channels 36 and 40, while the desired BSS operates on aggregated channels 44 and 48. Thus, if the neighboring BSS uses a secondary channel, other channels, including the primary channel, are usable by the desired BSS.

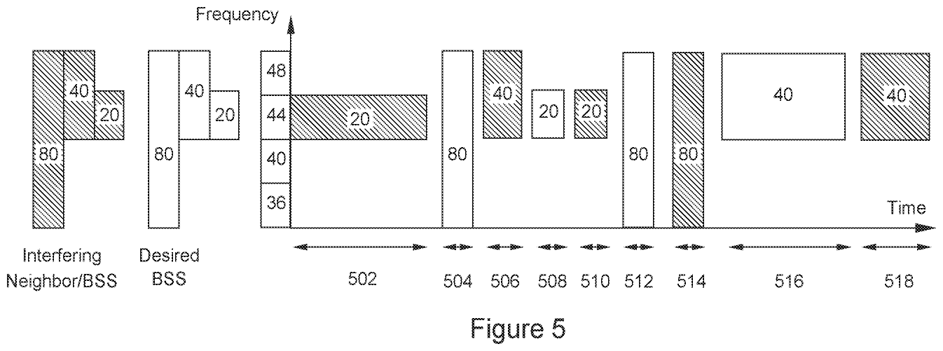

FIG. 5 depicts the operation of a primary channel without puncturing. In the figure, the primary channel is channel 44. In time period 502, the neighboring BSS occupies primary channel 44. No other channels can be used. In time period 504, the desired BSS operates on aggregated channels 36-48. No other channels are available. In time period 506, the neighboring BSS occupies aggregated channels 44 and 48. Because the primary channel is occupied, no other channels can be used. In time period 508, the desired BSS uses primary channel 44, and in time period 510, the neighboring BSS uses primary channel 44. During time periods 508 and 510, no other channels can be used. During time periods 512 and 514, the desired BSS and then the neighboring BSS use aggregated channels 36-44. No bandwidth is lost during time periods 512 and 514. In time period 516, the desired BSS occupies aggregated channels 44 and 48. No other channels can be used during time period 516. In time period 518, the neighboring BSS occupies aggregated channels 44 and 48. No other channels can be used during time period 518. Thus, significant bandwidth is wasted during time periods 502, 506, 508, 510, 516, and 518.

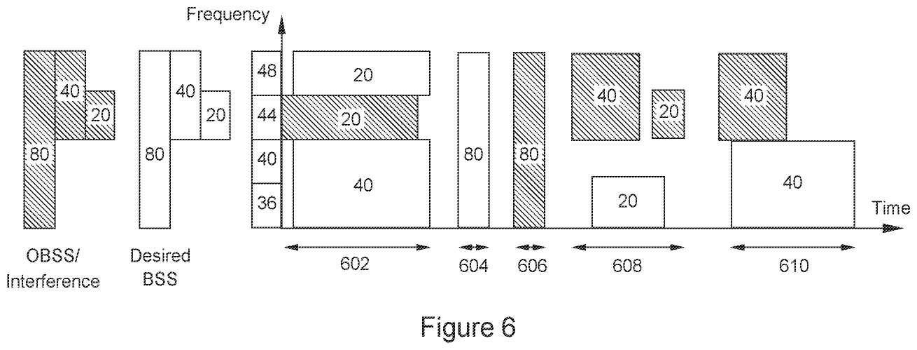

FIG. 6 depicts puncturing by a primary channel, in an embodiment. In the figure, the primary channel is 44. In time period 602, the primary channel 44 is occupied by the neighboring BSS, but the desired BSS operates on aggregated channels 36 and 40 and channel 48. In time period 604, the aggregated channels 36-48 are occupied by the desired BSS. In time period 606, the aggregated channels 36-48 are occupied by the neighboring BSS. In time period 608, the aggregated channels 44 and 48 are occupied by the neighboring BSS, and then the primary channel 44 is occupied by the neighboring BSS. During time period 608, channel 36 is now usable by the desired BSS. In time period 610, aggregated channels 44 and 48 are occupied by the neighboring BSS, while the desired BSS uses aggregated channels 36 and 40. Thus, during time periods 602, 608, and 610, utilization of available bandwidth is substantially improved compared to that of FIG. 5.

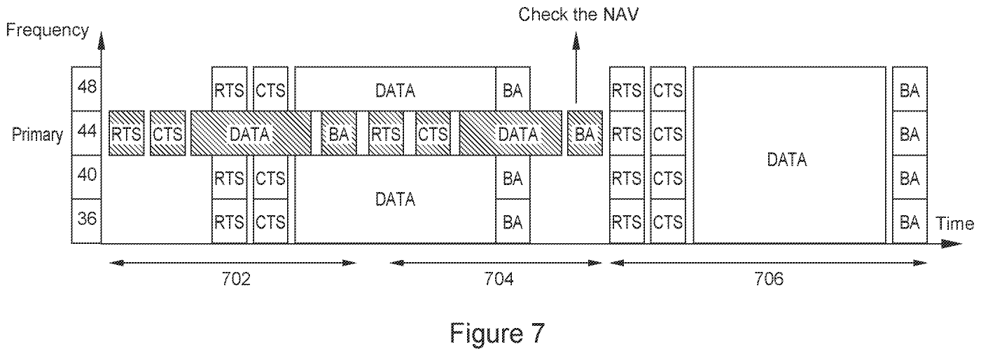

FIG. 7 depicts puncturing by a primary channel with an RTS frame and a CTS frame in an embodiment. In time periods 702 and 704, the neighboring BSS operates on the primary channel 44, sending an RTS frame, receiving a CTS frame, then sending data, and finally receiving a block acknowledgment. During time periods 702 and 704, the desired BSS operates on aggregated channels 36, 40, and channel 48, sending an RTS frame, receiving a CTS frame, sending data, and receiving a block acknowledgment. The neighboring BSS uses RTS and CTS frames, which reserve a transmission opportunity (TXOP) time and includes a NAV value in the block acknowledgment frames. Stations internally maintain a NAV timer which is updated from frames specifying how long the medium is to be used. Combining the RTS and CTS frames and a NAV value in the block acknowledgment informs the desired BSS as to how long the primary channel is used so that the desired BSS does not try to use the primary channel while used by the neighboring BSS. Thus, during time periods 702 and 704, utilization of available bandwidth is improved compared to the lack of puncturing in FIG. 5. In time period 706, the desired BSS uses an aggregated channel (36-48), transmitting RTS and receiving CTS on each channel to reserve the channels.

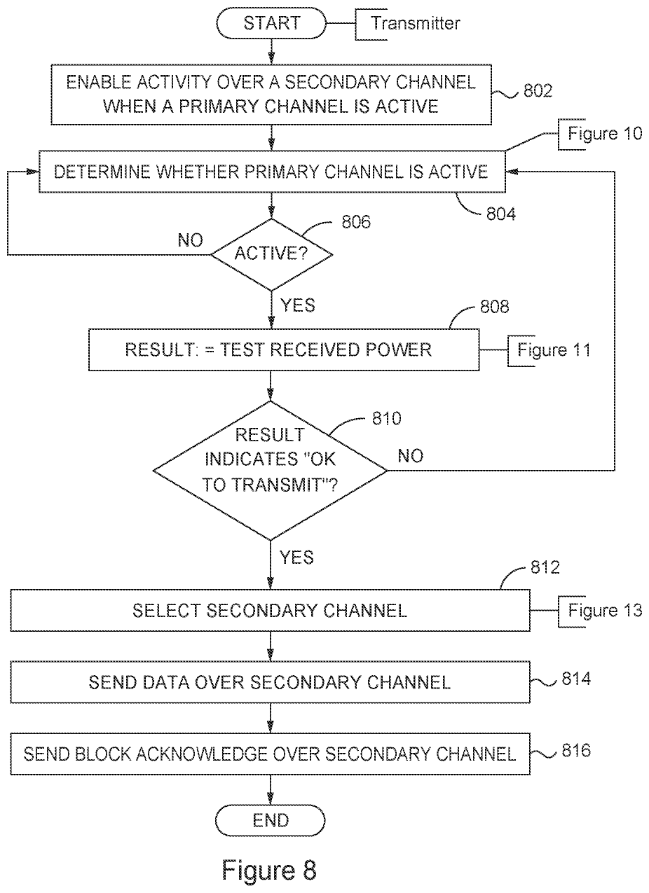

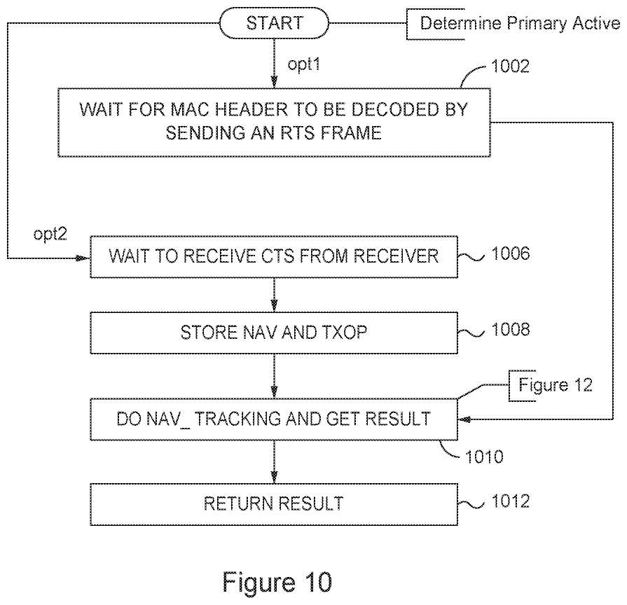

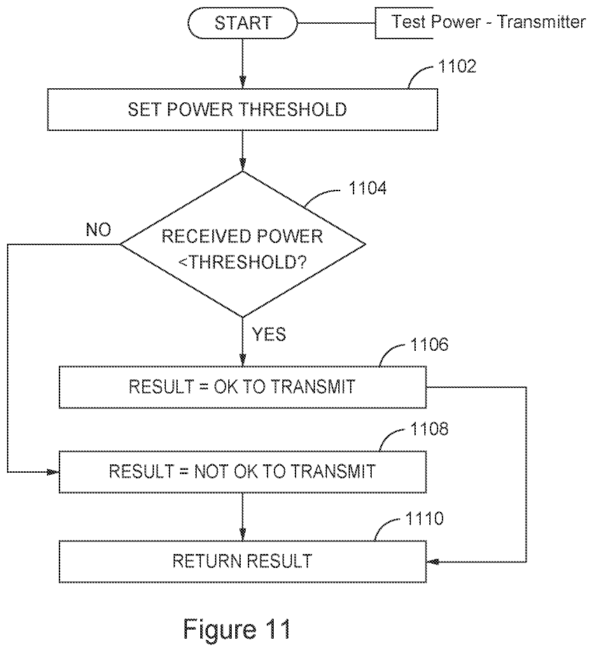

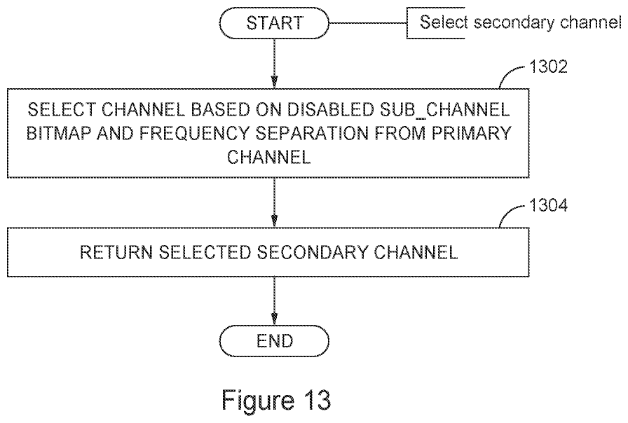

FIG. 8 depicts a flow of operations for a transmitter, in an embodiment. In block 802, a STA (access point or UE in the BSS of the access point) enables activity to occur over a secondary channel when a primary channel is active. In block 804, the STA determines whether the primary channel is active according to the function described in reference to FIG. 10. If the primary channel is active as determined in block 806, then in block 808, the STA tests the received power according to the function described in reference to FIG. 11. If the result of the test power function indicates that it is ‘ok to transmit’ as determined in block 810, then in block 812, the STA selects a secondary channel according to the test power function described in reference to FIG. 13. If the result of the test power function indicates that it is not ‘ok to transmit,’ then the STA returns to block 804. In block 814, the STA sends data over the secondary channel. In block 816, the STA sends a block acknowledge (BA) over the secondary channel after sending the data.

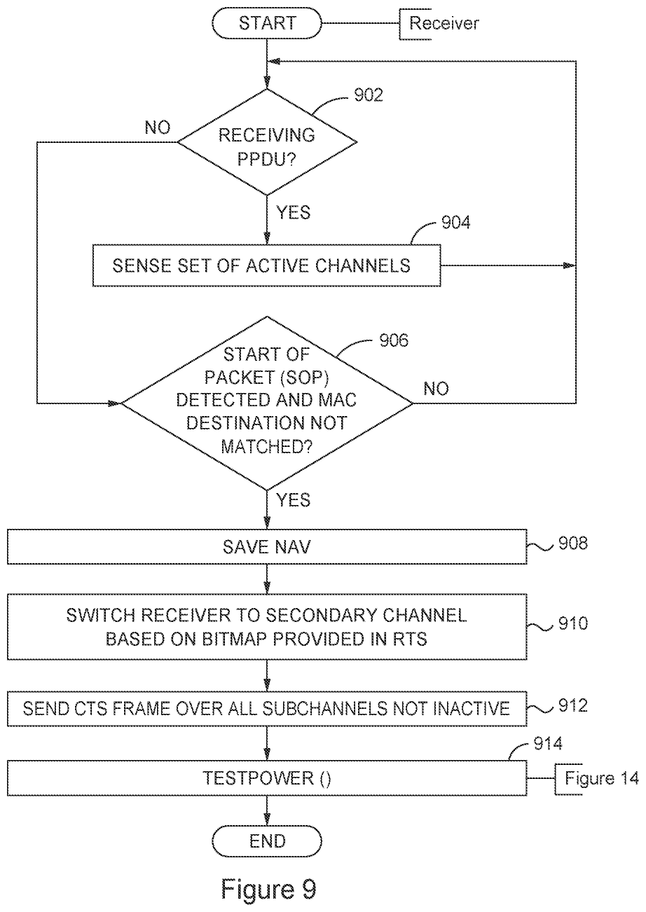

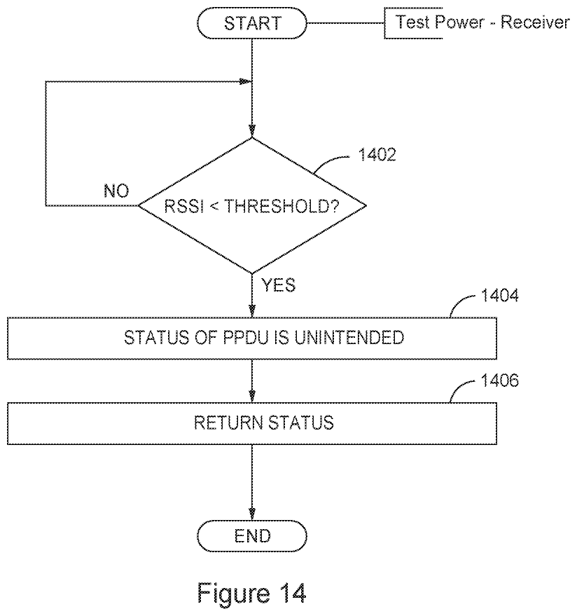

FIG. 9 depicts a flow of operations for a receiver, in an embodiment. In block 902, the STA determines whether it is receiving a PPDU. While receiving and processing the PPDU on the primary channel, the STA concurrently senses 20 MHz sub-channels in block 904, i.e., the entire set of active sub-channels. In another embodiment, the STA senses the active 20 MHz channels individually. In block 906, the STA with the receiver determines whether a start of packet (SOP) is detected and that the medium access layer (MAC) destination indicates that the packet is not coming from the STA's associated AP. In some embodiments, the SOP may start on a second primary channel that has a maximum distance to the primary channel, where the second primary channel is one defined for a secondary sub-channel. In block 908, if the SOP is detected and the MAC destination is not coming from the STA's associated AP, then the STA saves the NAV value in the frame locally. In block 910, the STA switches the receiver to the secondary channel based on the RTS bitmap. In block 912, the STA sends a CTS frame over all sub-channels that are not in the INACTIVE_SUBCHANNELS field. In block 914, the STA performs a test power function, which is further described in reference to FIG. 14.

One of the challenges of puncturing the channel access on the primary channel contention is the lack of tracking the status of NAV value in the primary channel while transmitting. Therefore, the transmitter may return to the primary channel after punctured transmission, and physically carrier sense the primary channel with no contention. However, channel contention occurs if the TXOP is still unfinished.

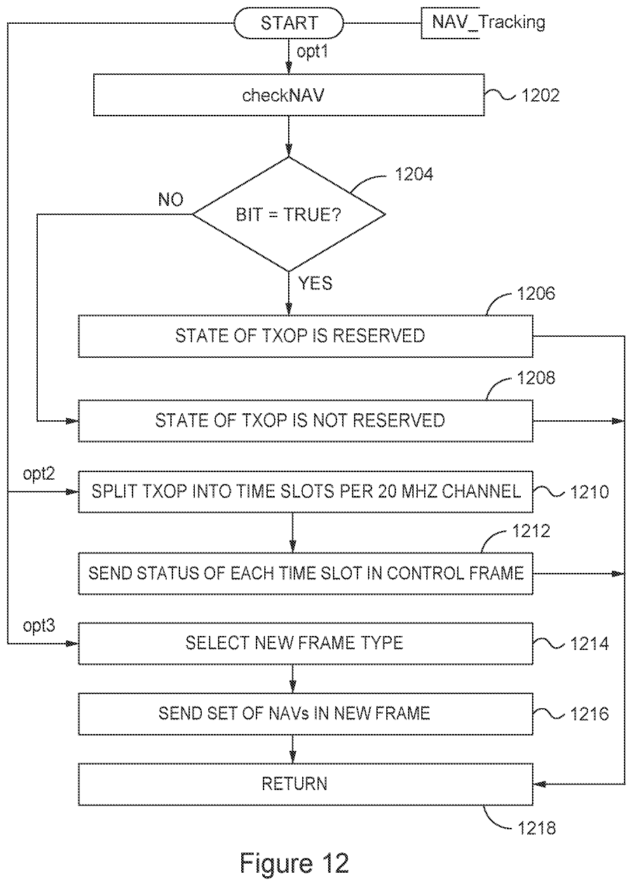

FIG. 10 depicts a flow of operations with several options for determining whether a primary channel is active to avoid contention. In option 1 (block 1002), the function waits for the MAC header to be decoded. In option 2 (block 1004), the function waits to receive RTS from the receiver. In option 3 (blocks 1006 and 1008), the function waits to receive CTS from the receiver and then stores the NAV value and TXOP, preserving the virtual carrier sense of the primary channel. Deciding whether the primary is active based on CTS provides more certainty regarding the actual usage of the primary channel. In block 1010, the function performs the NAV_tracking function, which is described in reference to FIG. 12. In block 1012, the function returns the result of any one of the options. The result is used in blocks 804 and 806 of FIG. 8.

FIG. 11 depicts a flow of operations for a test power function, in an embodiment. The test power function helps determine whether a channel is free or not. The function may employ the clear channel assessment (CCA) mechanism in which received power, or energy is compared against thresholds to make the determination.

In block 1102, the power or energy threshold is set. The threshold is defined to suppress unintended primary channel usage based on distance and ranges between −62 dBm and −82 dBm. In one embodiment, the default energy detection (ED) threshold is set at −62 dBm. In other embodiments, the ED threshold is set at −72 dBm.

In block 1104, if the received power is less than the threshold and more than the preamble detection (PD) threshold (−85 dBm) or ED threshold (−76 dBm if the noise floor is-100 dBm), then in block 1106, the function sets the result to ‘ok to transmit,’ and in block 1110 returns that value.

Otherwise, in block 1108, the function sets the result to ‘not ok to transmit’ and returns that result in block 1110.

When the duration of the punctured PPDU is larger than the NAV value of the primary, the transmitter does not know if another transmission happened in the primary and what the duration of the TXOP is. Without this knowledge, the transmitter may cause a collision by using the primary channel in the middle of TXOP. The NAV_tracking function helps the transmitter know the duration of the TXOP.

FIG. 12 depicts a flow of operations with several options for a NAV_tracking function, in an embodiment. The purpose of the NAV_tracking function is to determine when the primary channel is active to avoid collisions in the primary channel.

In option 1 (block 1202), the function tests the NAV value, which may reside in various control response frames such as acknowledge (ACK), BA, CTS, etc. This allows the transmitter to monitor the primary channel before transmitting in the entire bandwidth. A bit is assigned to each frame (i.e., a bit per frame). If a bit assigned to a frame is true, as determined in block 1204, the function determines in block 1206 that the state of the TXOP is still reserved. Otherwise, in block 1208, the function determines that the state of the TXOP is not reserved.

In option 2 (blocks 1210, 1212), the function splits the maximum TXOP size into time slots per 20 MHz channel and provides the status of each corresponding time slot in each sub-band via control frames. With a NAV value per 20 MHz, there is a total of 208 bits (320 MHz/20 MHz*log 2 (8 m sec/1 us)=16*13 bits).

In option 3 (blocks 1214, 1216), the selects a previously created new frame type, called a multichannel NAV update frame, and sends the set of NAV values in the new frame after the BA or ACK. In block 1218, the function returns after executing any of the options.

FIG. 13 depicts a flow of operations for a select_secondary_channel function, in an embodiment. In block 1302, the function selects a secondary channel based on frequency separation from the primary channel and the disabled sub_channel bitmap. The frequency separation is selected to have maximum frequency separation from the primary channel if the entire bandwidth of the BSS is not being used. The disabled sub_channel bitmap is a 16-bit map in which a lowest numbered bit corresponds to the 20 MHz sub_channel that lies within the BSS bandwidth, and that has the lowest frequency of the set of all 20 MHz sub_channels within the BSS bandwidth. No modification in this field is required, and it can include the primary channel in the inactive list. In block 1304, the function returns the selected secondary channel.

FIG. 14 depicts a flow of operations for a Test_Power function for the receiver, in an embodiment. In block 1402, the function determines whether the received signal strength indication (RSSI) is less than a threshold. If so, then in block 1404, the function determines that the PPDU not coming from the intended client/AP is, and in block 1406, returns the status of the PPDU.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational blocks to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method of transmitting and receiving in a secondary channel when a primary channel is active, the method comprising:
enabling activity over the secondary channel of a basic service set (BSS) operating in a wireless medium when the primary channel of the BSS is active;
determining that the primary channel is active;
upon determining that the primary channel is active,
transmitting an RTS frame over the secondary channel to reserve the secondary channel for a specified duration and receiving a CTS frame in the secondary channel in response to the RTS frame; and
transmitting data over the secondary channel.

2. The method of claim 1, wherein determining that the primary channel is active includes waiting for a receiver connected to the primary channel to decode a medium access layer (MAC) header of a frame transmitted over the primary channel by sending an RTS frame.

3. The method of claim 1, wherein determining that the primary channel is active includes waiting for a CTS frame from the receiver after sending an RTS frame to the receiver.

4. The method of claim 1,
wherein the primary channel has a center frequency,
wherein the secondary channel is an aggregation of channels within a bandwidth of the BSS, and
wherein the aggregation of channels includes channels having center frequencies less than or greater than the center frequency of the primary channel and excludes the primary channel.

5. The method of claim 4, wherein the secondary channel has a center frequency that has a maximum frequency separation from the center frequency of the primary channel.

6. The method of claim 1,
wherein a bitmap available to the BSS defines inactive channels within a bandwidth of the BSS, a lowest numbered bit in the bitmap corresponding to a channel having a lowest center frequency of channels in the bandwidth of the BSS;
further comprising selecting a secondary channel for use based on the bitmap.

7. The method of claim 1,
wherein the primary channel is active with a transmission opportunity (TXOP) and then with a block acknowledgment (BA) frame, and
wherein the BA frame contains a NAV value that is checked to determine whether a TXOP in the primary channel is reserved after the TXOP.

8. The method of claim 7, wherein the NAV value includes a bit per frame in the TXOP to indicate a duration that the primary channel is active.

9. The method of claim 7, wherein a maximum TXOP size is divided into time slots per channel and control frames provide status of each time slot.

10. An access point for transmitting and receiving in a secondary channel when a primary channel is active, the access point comprising:
a processor; and
a memory coupled to the processor and storing an application configured to, when executed by the processor, perform an operation, the operation comprising:
enabling activity over the secondary channel of a basic service set (BSS) operating in a wireless medium when the primary channel of the BSS is active;
determining that the primary channel is active;
upon determining that the primary channel is active, transmitting an RTS frame over the secondary channel to reserve the secondary channel for a specified duration and receive a CTS frame in the secondary channel in response to the RTS frame; and
transmitting data over the secondary channel.

11. The access point of claim 10,
wherein the primary channel has a center frequency,
wherein the secondary channel is an aggregation of channels within a bandwidth of the BSS,
wherein the aggregation of channels includes channels having center frequencies less than or greater than the center frequency of the primary channel and excludes the primary channel, and
wherein the secondary channel has a center frequency that has a maximum frequency separation from the center frequency of the primary channel.

12. The access point of claim 10,
wherein a bitmap available to the BSS defines inactive channels within a bandwidth of the BSS, a lowest numbered bit in the bitmap corresponding to a channel having a lowest center frequency of channels in the bandwidth of the BSS, and
wherein the operation further comprises selecting one of the inactive channels as the secondary channel for use based on the bitmap.

13. The access point of claim 10,
wherein the primary channel is active with a transmission opportunity (TXOP) and then with a block acknowledgment (BA) frame, and
wherein the BA frame contains a NAV value that is checked to determine whether a TXOP in the primary channel is reserved after the TXOP.

14. The access point of claim 13, wherein the NAV value includes a bit per frame in the TXOP to indicate a duration that the primary channel is active.

15. The access point of claim 13, wherein a maximum TXOP size is divided into time slots per channel and control frames provide a status of each time slot.

16. A non-transitory computer-readable medium encoding instructions, which, when executed by a processor of an access point coupled to a wireless medium, cause the access point to:
enable activity over a secondary channel when a primary channel of a basic service set (BSS) is active;
determine that the primary channel is active;
upon determining that the primary channel is active, transmit an RTS frame over the secondary channel to reserve the secondary channel for a specified duration and receive a CTS frame in the secondary channel in response to the RTS frame; and
transmit data over the secondary channel.

17. The non-transitory computer-readable medium of claim 16,
wherein the primary channel has a center frequency,
wherein the secondary channel is an aggregation of channels within a bandwidth of the BSS,
wherein the aggregation of channels includes channels having center frequencies less than or greater than the center frequency of the primary channel and excludes the primary channel, and
wherein the secondary channel has a center frequency that has a maximum frequency separation from the center frequency of the primary channel.

18. The non-transitory computer-readable medium of claim 16,
wherein a bitmap available to the BSS defines inactive channels within a bandwidth of the BSS, a lowest numbered bit in the bitmap corresponding to a channel having a lowest center frequency of channels in the bandwidth of the BSS, and
wherein instructions further cause the access point to select one of the inactive channels as the secondary channel for use based on the bitmap.

19. The non-transitory computer-readable medium of claim 16,
wherein the primary channel is active with a transmission opportunity (TXOP) and then with a block acknowledgment (BA) frame, and
wherein the BA frame contains a NAV value that is checked to determine whether a TXOP in the primary channel is reserved after the TXOP.

20. The non-transitory computer-readable medium of claim 19, wherein the NAV value includes a bit per frame in the TXOP to indicate a duration that the primary channel is active.
